(19) United States
(12) Patent Application Publication
(10) Pub. No.: US 2020/0216233 A1
(43) Pub. Date: Jul. 9, 2020

(54) CONTAINER CAP INCLUDING TWO-WAY DUCKBILL VALVE

(71) Applicant: Myung Ho KIM, Namyangju, Gyeonggi (KR)

(72) Inventor: Myung Ho KIM, Namyangju, Gyeonggi (KR)

(21) Appl. No.: 16/628,026

(22) PCT Filed: Mar. 26, 2018
(86) PCT No.: PCT/KR2018/003520

§ 371 Date: Jan. 1, 2020

(30) Foreign Application Priority Data
Jul. 10, 2017 (KR) 10-2017-0087160

(51) Int. Cl. B65D 47/20; B65D 41/04; B65D 41/26; G01F 11/26

(52) U.S. Cl. CPC B65D 47/2031; G01F 11/263; B65D 41/26; B65D 41/04

(57) ABSTRACT

The present invention relates to a container cap including a two-way duckbill valve by modifying a valve shaped like the beak of a duck to be applied to a container cap, and more particularly, a container cap including a two-way duckbill valve wherein a two-way duckbill valve is secured to a container cap, enabling the content contained in a container to be easily controlled to be discharged in a desired amount, without using a measuring cup or a separable measuring cap.

### TECHNICAL FIELD

The present invention relates to a two-way duckbill valve which is shaped like the beak of a duck and is applied to a container cap to easily control the content of the container to be discharged in a desired amount, without using a measuring cup or a separable measuring cap, and to a container cap including the same.

### BACKGROUND ART

Generally, a cap is used for an opening of a container which stores a liquid content, such as sesame oil, cooking oil, syrup or a medicine, etc., or a flowable solid content, such as salt or sugar, etc. Such a cap comprises a discharge hole to discharge the liquid or solid content which is contained in a container. As the container is manipulated by a user, the liquid or solid content is allowed to discharge to the outside through the discharge hole.

When cooking food or compounding medicines by using the content of the container, since the content needs to be discharged from the container just as much as a desired amount to meet a desired ratio, the amount of the content is measured by using a special measuring cup or a cap which is graduated for measuring.

However, in the above-described case, there is an inconvenience to check the amount of the discharged content with the naked eye after discharging the content from the container into the measuring cup or cap. Further, since it is difficult to discharge the exact amount of the content, the amount of the content actually discharged is either short or too much. Further, when the content is excessively discharged, the measuring cup and the excessive content are contaminated and an unnecessary loss of the content occurs.

As a result of searching the prior art related to the present invention, a number of patent documents have been found. Some of the patent documents are described below:

Patent Document 1 (Korean Published Patent Application No. 10-2004-0023480 A) is related to a quantitative cup, wherein an elastically changeable hook piece extending from an outer periphery, and a part extending in an approximately ⊏-shape to be held by the hook piece are formed in a cap main body. The hook piece passes through a through-hole formed by the part. The hook piece holds a front lower edge end of the part, to integrate a lid and the cap main body. The lid to open and close a discharge hole of a container is connected to a top end of the container. The lid is graduated to measure the amount of a content contained in the container. Thus, this document discloses an internal cap inside the lid which is used to discharge the content in a desired amount in the state when the lid is opened.

In the internal cap of Patent Document 1, the lid simply performs only the function of a measuring cup. However, since the amount of the content to be discharged is not regular due to the viscosity of the content during the process of discharging the content into the lid, it fails to accurately meet the desired amount or the content flows out of the lid, causing waste of the content or contamination of the surroundings.

Patent Document 2 (Korean Published Patent Application No. 10-2004-0039224 A) discloses a lid having a content storage space with a check valve, wherein the lid which stores different kinds of contents is connected to a container. In use, the lid is opened, turned or pressed to drop the contents present in the storage space. A user drinks the contents through a discharging tube which is assembled with a check valve in the storage space.

According to the lid of Patent Document 2, even though the container falls during use, since the contents do not flow out by the check valve, it can be easily used by a young child or the elderly. However, it has a disadvantage in that it has no function of quantitatively discharge of the content.

Patent Document 3 (Korean Utility Model Registration No. 20-0464780 Y1) is described with a dual structure storage container having a pumping function by a check valve. The container comprises a dual structure of an elastic tube and a bag which contains a cosmetic liquid or a detergent; a nozzle cap with a discharge hole, to be connected to an upper connection part of the container; a suction check valve positioned at the tube, to suction external air inside by pressing the tube; and a discharge check valve positioned at the discharge hole of the nozzle cap, to discharge the content outside by pressing the bag. With the pumping action by pressing the tube, the bag is gradually pressed to discharge the content.

However, in Patent Document 3, since the two check valves are positioned at different positions such that the suction check valve is positioned at the container itself and the discharge check valve is positioned at the neck of the container, there are disadvantages in that the value is low and it is inconvenient to use.

As a result of researching for a long time to solve the above-mentioned problems of the conventional art, the present applicant filed a two-way duckbill valve and a container cap including the same as disclosed in Patent Document 4 (Korean Published Patent Application No. 10-2016-0133801 A). According to the two-way duckbill valve and the container cap including the same control disclosed in this document, since the content of the container is easily controlled in a desired amount, without using a measuring cup or a separable measuring cap, and then is discharged, the content of the container is prevented from discharging all at once.

The invention filed in Patent Document 4 discloses the two-way duckbill valve which controls two channels at the same time such as, with respect to one input, one channel is controlled to be opened while the other channel is controlled to be closed, vice versa. This prior art also discloses a container cap comprising an inner cap which is positioned at the top of the container, is connected to the neck of the container to discharge the content to the outside and is connected to the two-way duckbill valve; and a cover cap which threadedly engages the neck of the container and surrounds the inner cap.

However, since the two-way duckbill valve of the prior art mentioned above has the disadvantage in that airtightness is not well kept on the features of the internal shape and the container cap including the two-way duckbill valve has a complicated structure, the cost is high and productivity is low.

### RELATED ART DOCUMENTS

### Patent Documents

(Patent Document 1) KR10-2004-0023480 A

(Patent Document 2) KR10-2004-0039224 A

(Patent Document 3) KR20-0464780 Y1

(Patent Document 4) KR10-2016-0133801 A

### DISCLOSURE

### Technical Problem

Therefore, it is an object of the present invention to solve the above problems and to provide a container cap including a two-way duckbill valve which uses a duckbill valve, instead of a publicly known check valve, to simplify the internal constitution of the container cap and therefore to improve productivity.

It is another object of the present invention to provide a container cap including a two-way duckbill which uses the elasticity of a bottom valve seat forming the two-way duckbill valve, to set the capacity of an inner cap and to discharge a quantitative content.

### Technical Solution

In accordance with an embodiment of the present invention, there is provided a container cap including a two-way duckbill valve comprising: a container cap comprising: a duckbill valve (10) having a structure which gradually narrows from a cylindrical shape to a flattened shape and including a first channel (14) in a straight line shape and a second channel (15) in an arc shape, wherein when a pressing force is simultaneously applied to the first channel (14) and the second channel (15), the first channel (14) and the second channel (15) are separately opened and closed opposite to each other such that when the first channel 14 is opened, the second channel is closed, and vice versa; an inner cap (20) connected to the inside of a container neck (51) to discharge in use content (52) contained in a container (50), wherein the two-way duckbill valve (10) is positioned at the bottom of the inner cap (20) and a certain amount of the content (52) is stored in the inner cap (20); a valve holder (30) connected to the lower part of the inner cap (20), to secure the two-way duckbill valve (10); and a cover cap (40) threadedly engaging a container neck (51), wherein the upper end of the inner cap (20) fits into the cover cap (40).

Further, the two-way duckbill valve (10) in the structure which gradually narrows from the cylindrical shape to the flattened shape comprises: a valve body (11) in which the first channel (14) is formed at the upper end of the flattened shape; a valve base (12) in a ring shape which is secured by the valve holder (30) and which the valve body (11) fits into; and a bottom valve seat (13) which is the lower end of the valve body (11), wherein the second channel (15) is formed between the bottom valve seat (13) and the inner circumferential surface of the valve base (12), and when a pressing force is simultaneously applied to the first channel (14) and the second channel (15), the valve body (11) and the bottom valve seat (13) are structured to separately open and close the first channel (14) and the second channel (15) opposite to each other.

Further, the inner cap (20) comprises: a body (21) in a cylindrical shape which fits into the inside of the container neck (51) and in which the content (52) is stored; a flange (22) which extends outwardly from the top end of the body (21) so as to be placed on the top end of the container neck (51); a lower support (23) formed at the bottom end of the body (21) such that the valve base (12) of the two-way duckbill valve (10) is seated; an internal threaded part (24) formed in the lower inside circumferential surface of the body (21) to secure the valve holder (30); and a sealing (25) positioned between the flange (22) and the top end of the container neck (51).

Further, the valve holder (30) comprises: an external threaded part (31) formed on the outer circumferential surface of the valve holder (30); and two or more tool connection holes (32) formed on the top side of the valve holder (30).

Further, the valve holder (30) further comprises a pressing protrusion (33) formed along the lower inside edge of the valve holder (30), to press the top side of the valve base (12) forming the two-way duckbill valve (10).

Further, the cover cap (40) comprises: an external connection part (41) threadedly engaging the outer circumferential surface of the container neck (51), to be sealed; and an internal connection part (42) protruding downwardly from the inside of the top of the cover cap (40) so that the inner cap (20) fits into the cover cap (40).

Further, the cover cap (40) further comprises: a sealing member (43) connected to the outside of the internal connection part (42), to press the top end of the inner cap (20) so as to be sealed.

### Advantageous Effects

In the container cap including a two-way duckbill valve according to the present invention, since the two-way duckbill valve is removably connected to the lower end of the inner cap by the valve holder, it is possible to separate the two-way duckbill valve to be cleaned as needed, thereby enabling hygienic care. Further, during the process in which the content of the container is transferred into the inner cap or the content of the inner cap returns into the container, since the first channel and the second channel of the two-way duckbill valve are selectively opened and closed opposite to each other, reliability is improved and since the inside structure is simplified, productivity is improved.

Further, since the sealing is inserted between the flange extended on the top of the inner cap and the container neck, the content of the container is prevented from leaking between the container neck and the inner cap. Further, since the sealing member is inserted between the flange of the inner cap and the cover cap, the content stored in the inner cap is prevented from leaking

Further, since the size of one channel to be opened and the sealing force of the other channel are increased as the pressure applying to the two-way duckbill valve becomes greater, it is possible to rapidly store a great amount of the content into the inner cap or to control the amount of the content to be stored. Further, when pressure is not applied to the two-way duckbill valve, all channels are closed so that the amount of content stored in the inner cap is kept constant. When the content is above a predetermined amount in the inner cap, the excessive content returns into the container by opening the cover cap so that the content is quantitatively discharged.

Further, since the two-way duckbill valve is secured by the valve holder connected to the inner cap, the two-way duckbill valve is prevented from separating, and since the protrusion formed inside the lower end of the valve holder presses the valve base of the two-way duckbill valve, the opening of the second channel formed between the valve base and the bottom valve seat is controlled by tightening the valve holder, thereby controlling the capacity of the inner cap.

### DESCRIPTION OF DRAWINGS

These and other aspects and advantages of the present invention will become apparent and more readily appreciated from the following description of the embodiment(s), taken in conjunction with the accompanying drawings, in which:

FIG. 1 is a whole cut perspective view of a container cap according to the present invention;

FIG. 2 is an exploded perspective view of the contain cap;

FIG. 3 is a cut exploded perspective view of a two-way duckbill valve, an inner cap and a valve holder;

FIG. 4 is a sectional view of the container cap;

FIG. 5 is a sectional view of the container in which the content is stored;

FIG. 6 is a sectional view of the container which is upside down;

FIG. 7 is a sectional view of the content moved into the inner cap by pressing the container;

FIG. 8 is a sectional view of the content stored in the inner cap;

FIG. 9 is a sectional view of a cover cap which is separated for the user to drink the content or to discharge the content; and

FIG. 10 is a sectional view that the content which is over a predetermined amount returns into the container by opening the cover cap.

### DESCRIPTION OF NUMBERS AND CONSTITUENTS IN DRAWINGS

10: two-way duckbill valve
11: valve body
12: valve base
13: bottom valve seat
20: inner cap
21: body
22: flange
23: lower support
24: internal threaded part
25: sealing
30: valve holder
31: external threaded part
32: tool connection hole
33: pressing protrusion
40: cover cap
41: outer connection part
42: inner connection part
43: sealing member
50: container
51: container neck
52: content

### DETAILED DESCRIPTION OF THE PREFERRED EMBODIMENTS

It will be understood that terms are used herein by selecting, as far as possible, general terms commonly used. However, some terms are selected based on the applicant's own discretion and in such cases, the terms should be interpreted by considering their meaning that is described or used in the specific content to carry out the invention and will not be interpreted in a sense of the meaning of simple terms.

The technical constitution of the present invention will now be described more fully hereinafter with reference to the accompanying drawings.

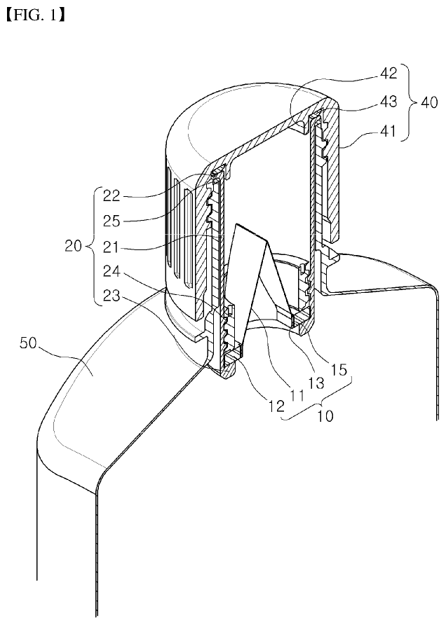

To this end, the present invention will be described based on FIG. 1 in which a container stands upright in a normal manner, unless a direction is specifically defined as shown in the drawings.

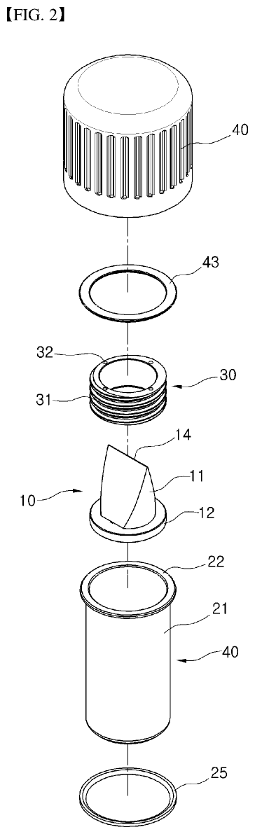

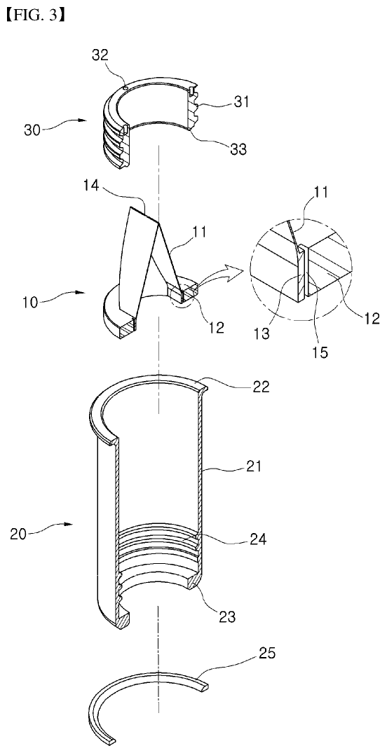

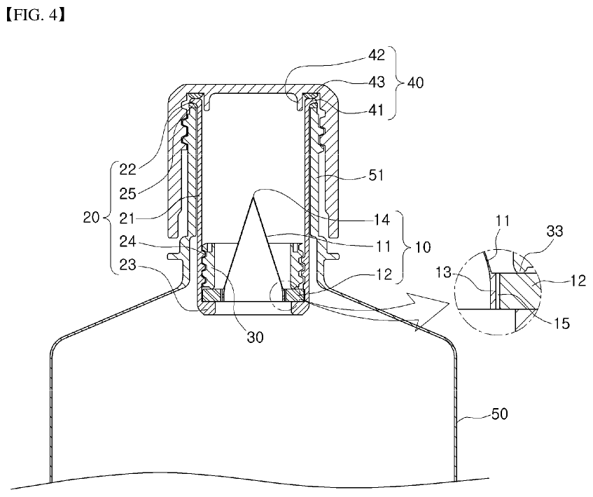

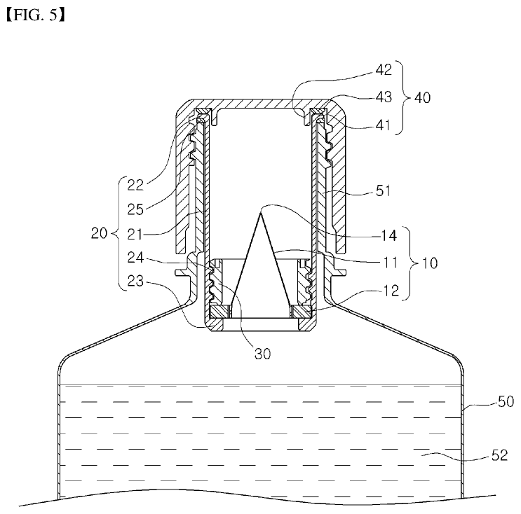

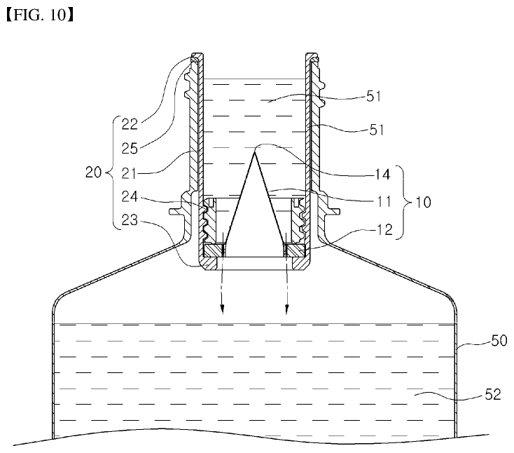

As shown in FIG. 1 through FIG. 10, a container cap including a two-way duckbill valve according to the present invention comprises: a duckbill valve 10, an inner cap 20, a valve holder 30 and a cover cap 40. The duckbill valve 10 in a structure that gradually narrows from a cylindrical shape to a flattened shape comprises a first channel 14 in a straight-line shape and a second channel 15 in an arc shape. When a pressing force is simultaneously applied to the first channel 14 and the second channel 15, the first channel 14 and the second channel 15 are separately opened and closed opposite to each other. The inner cap 20 is connected to the inside of a container neck 51 to discharge a content 52 contained in a container 50. The two-way duckbill valve 10 is positioned at the bottom of the inner cap 20 and a certain amount of the content 52 is stored in the inner cap 20. The valve holder 30 is connected to the lower part of the inner cap 20, to secure the two-way duckbill valve 10. The cover cap 40 threadedly engages the container neck 51, wherein the upper end of the inner cap 20 fits into the cover cap 40.

Usually, a duckbill valve as a one-way valve made of rubber has the structure that gradually narrows from a cylindrical shape to a flattened shape. This duckbill valve is a kind of a one-way valve in which a discharge hole is formed at the part in the flattened shape, allowing an outflow from the part in the cylindrical shape into the discharge hole at the part in the flattened shape but preventing an inflow from the part in the flatten shape to the part into the cylindrical shape. However, the present applicant has verified that it is possible to control an inflow and an outflow in two ways by modifying the structure of such a duckbill valve.

Specifically, the two-way duckbill valve 10 in the structure that gradually narrows from the cylindrical shape to the flattened shape comprises: a valve body 11 in which the first channel 14 is formed at the upper end of the flattened shape, a valve base 12 in a ring shape which is secured by the valve holder 30 and which the valve body 11 fits into, and a bottom valve seat 13 which is the lower end of the valve body 11, wherein the second channel 15 is formed between the bottom valve seat 13 and the inner circumferential surface of the valve base 12. When a pressing force is simultaneously applied to the first channel 14 and the second channel 15, the valve body 11 and the bottom valve seat 13 are structured to separately open and close the first channel 14 and the second channel 15 opposite to each other such that when the first channel 14 is opened, the second channel is closed, and vice versa.

Accordingly, during the content 52 is transferred from the container 50 into the inner cap 20 through the first channel 14 of the valve body 11, the bottom valve seat 13 is stuck to the valve base 12 so that the second channel 15 is closed. During the content 52 in the inner cap 20 returns into the container 50, the first channel 14 of the valve body 11 is closed and the bottom valve seat 13 is separated from the valve base 12 so that the second channel 15 is opened.

That is, the bottom valve seat 13 is changed or restored in shape based on the internal pressure of the inner cap 20, thereby opening or closing the second channel 15. The internal pressure is the total pressure of the weight of the content 52 stored in the inner cap and atmospheric pressure. Only when the content 52 in the inner cap 20 is above a predetermined amount and the cover cap 40 is opened so that the atmospheric pressure is applied, the bottom valve seat 13 is changed in shape, controlling the second channel to be opened.

Specifically, if the internal pressure of the inner cap 20 is more than the total pressure of the quantitative content and atmospheric pressure, the bottom valve seat 13 is separated from the valve base 12 and changed inwardly, to open the second channel 15. Of course, when the content 52 in the inner cap 20 is less than the total pressure, the bottom valve seat 13 does not change to keep its shape, so that the second channel 15 is kept the closed state. Accordingly, the bottom valve seat 13 is able to control the capacity of the inner cap 20 by using the change of the pressure and to discharge the content 52 quantitatively.

The inner cap 20 comprises: a body 21 in a cylindrical shape which fits into the inside of the container neck 51 and where the content 52 is stored, a flange 22 which extends outwardly from the top end of the body 21 so as to be placed on the top end of the container neck 51, a lower support 23 formed at the bottom end of the body 21 such that the valve base 12 of the two-way duckbill valve 10 is seated, an internal threaded part 24 formed in the lower inside circumferential surface of the body 21 to secure the valve holder 30, and a sealing 25 positioned between the flange 22 and the top end of the container neck 51.

The height of the body 21 is determined by considering the capacity of the content 52 to be stored in the inner cap 20. That is, when the capacity of the content 52 to be stored is small, the height of the body 21 is to be low, and when the capacity of the content 52 to be stored is great, the height of the body 21 is to be high. But, even if the height of the body 21 is high, the entire body 21 is to be positioned inside the container neck 52. This is because it is possible to completely discharge the content 52 contained in the container 50 only if the lower part of the body 21 is positioned to be higher than the lower end of the container neck 51. Therefore, the higher the height of the body 21 is, the longer the length of the container neck 51 is.

As the body 21 of the inner cap 20 fits into the inside of the container neck 51 and the sealing 52 is positioned between the flange 22 formed on the top end of the body 21 and the top end of the container neck 51, the content 52 contained in the container 50 is prevented from leaking into the gap between the flange 22 and the container neck 51.

The two-way duckbill valve 10 is mounted on the lower support 23 of the inner cap 20. The valve holder 30 is used to secure the two-way duckbill valve 10 so as not to move. The valve holder 30 includes an external threaded part 31 and two or more tool connection holes 32. The external threaded part 31 is formed on the outer circumferential surface of the valve holder 30 so as to threadedly engage the internal threaded part 24 formed on the lower inside circumferential surface of the inner cap 20. The tool connection holes 32 are formed on the top side of the valve holder 30.

Accordingly, the valve holder 30 is secured to the internal threaded part 24 formed on the lower inside of the inner cap 20 by connecting a tool to the tool connection holes 32, so that the two-way duckbill valve 20 positioned on the lower support 23 is firmly secured.

The valve holder 30 further includes a pressing protrusion 33 formed along the lower inside edge of the valve holder 30, preferably to press the top side of the valve base 12 forming the two-way duckbill valve 10. The pressing protrusion 33 presses the top side of the valve base 12, thereby changing an opening of the second channel 15 which is formed between the valve base 12 and the bottom valve seat 13. In the case where the opening of the second channel 15 is changed, since the internal pressure of the inner cap 20 when the content 52 inside the inner cap 20 returns to the container 50 is also changed, it is possible to control the internal pressure of the inner cap 20 for returning the content 52 through the second channel 15 by tightening the valve holder 30.

The cover cap 40 includes an external connection part 41, an internal connection part 42 and a sealing member 43 in a ring shape. The external connection part 41 threadedly engages the outer circumferential surface of the container neck 51, to be sealed. The internal connection part 42 protrudes downwardly from the inside of the top of the cover cap 40 so that the inner cap 20 is connected to the cover cap 40. The sealing member 43 is connected to the outside of the internal connection part 42, to press the top end of the inner cap 20 so as to be sealed.

Since the internal connection part 42 is connected into the inside of the top end of the inner cap 20 and the sealing member 43 is positioned between the inside of the top of the external connection part 41 and the flange 22 of the body 21, the content 52 inside the inner cap 20 is prevented from leaking to the outside.

A process of discharging or drinking the quantitative content by using the container cap including the two-way duckbill valve according to the present invention will be described below:

First, the two-way duckbill valve 10 is inserted into the inner cap 20 so that the valve base 12 of the two-way duckbill valve 10 is positioned on the lower support 23 of the inner cap 20 and then the valve holder 30 inserted into the inner cap 20 is fastened to the internal threaded part 24 formed at the upper side of the lower support 23. The two-way duckbill valve 10 uses the strain pressure of the bottom valve seat 13 to be determined by considering the set storage amount of the inner cap 20, and the valve holder 30 is to be fastened based on a predetermined tightening force of the valve holder 30.

Subsequently, after the content 52 is poured into the container 50, the inner cap 20 is pressed in by positioning the sealing 25 at the container neck 51, to prevent the content 52 inside the container 50 from leaking through the container neck 51. Then, the cover cap 40 is connected to the container neck 51 by positioning the sealing member 43 to prevent the inner cap 20 from separating and to prevent the content 52 inside the inner cap 20 from leaking.

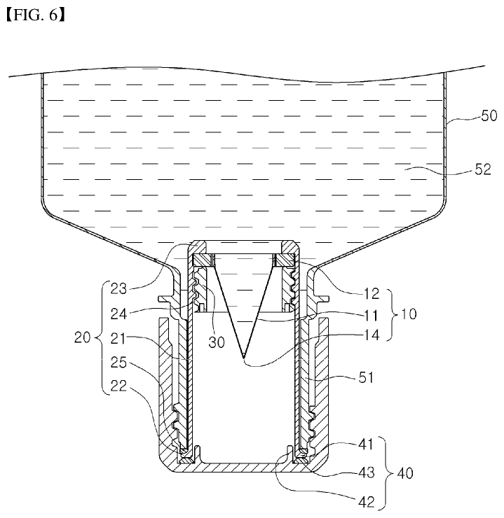

In the case where the container 50 with the cover cap 40 closed is upside down to quantitatively discharge the content 52 of the container 50, since the pressure taken on the inside and the outside of the two-way duckbill valve 10 is substantially equal in the state when any additional pressure is not applied, the content 52 of the container 50 does not flow out into the inner cap 20 as shown in FIG. 6.

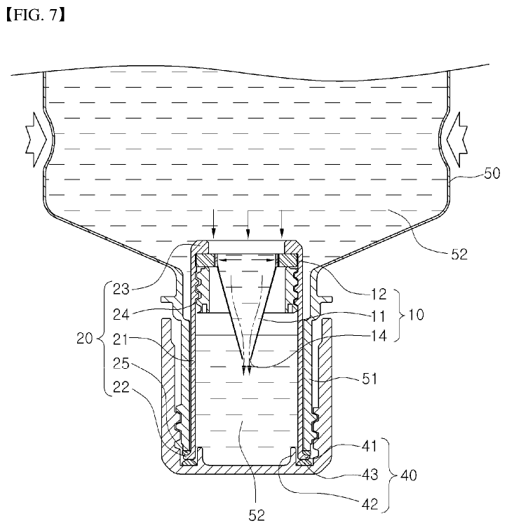

In the same case that the container 50 is upside down as described above, if pressure is applied to the container 20, the pressure acts to the inside of the two-way duckbill valve 10 through the content 52 as shown in FIG. 7. Accordingly, the first channel 14 formed at the top end of the valve body 11 of the two-way duckbill valve 10 is opened and the second channel 15 formed between the bottom valve seat 13 and the valve base 12 is kept closed, so that the content 52 of the container 50 moves through the first channel 14, to be stored in the inner cap 20.

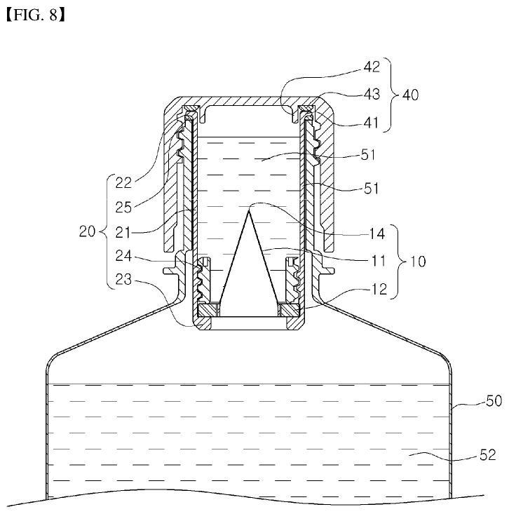

After the content 52 is stored in the inner cap 20, even though the container 50 is positioned upright again, the content 52 inside the inner cap 20 is maintained as it is as shown in FIG. 8.

That is, since the pressure applied to the inside and the outside of the two-way duckbill valve 10 is kept equally, the first channel 14 and the second channel 15 are both kept closed and therefore the content 52 inside the inner cap 20 does not flow into the container 50.

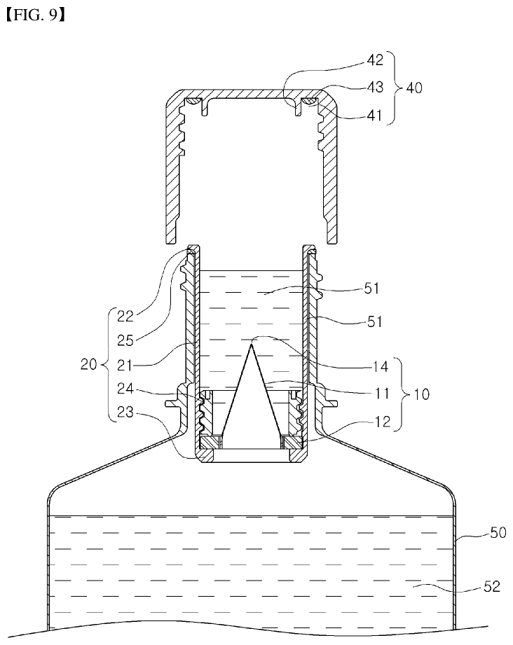

However, when the cover cap 40 is open and removed, the atmospheric pressure is additionally applied to the content 52 inside the inner cap 20 as shown in FIG. 9. In this case, since the pressure acting on the outside of the valve body 11 of the two-way duckbill valve 10 increases, the first channel 14 is kept in the closed state. Further, the second channel 15 is opened by the pressure applied on the outside of the bottom valve seat 13 formed at the lower position of the valve body 11.

That is, the second channel 15 between the bottom valve seat 13 and the valve base 12 is opened or closed, based on the weight of the content 52 inside the inner cap 20 and the action of the atmospheric pressure. When the second channel 15 is opened, since the first channel 14 formed at the top/upper end of the valve body 11 is kept in the closed state, the content 52 inside the inner cap 20 returns into the container 50 through the second channel 15.

When some of the content 52 inside the inner cap 20 returns into the container 50 and the quantitative content 52 is remained, the bottom valve seat 12 restores by elasticity, thereby closing the second channel 15. When the content 52 inside the inner cap 20 is less than a desired amount, the second channel 15 is kept in the closed state even though the atmospheric pressure acts.

Accordingly, the content 52 in a desired amount is discharged by positioning the container 50 containing the content 52 upside down to opening the first channel 14 so that the content 52 of the container 50 in a sufficient amount is stored inside the inner cap 20 and then by opening the cover cap 40 so that an excess of the content 52, which is stored in more than the desired amount in the inner cap 20, returns to the container 50 and only the quantitative content 52 is discharged.

The invention has been described using preferred exemplary embodiments. However, it is to be understood that the scope of the invention is not limited to the disclosed embodiments. On the contrary, the scope of the invention is intended to include various modifications and alternative arrangements within the capabilities of persons skilled in the art using presently known or future technologies and equivalents. The scope of the claims, therefore, should be accorded the broadest interpretation so as to encompass all such modifications and similar arrangements.

1. A container cap comprising:
a duckbill valve (10) having a structure which gradually narrows from a cylindrical shape to a flattened shape and including a first channel (14) in a straight line shape and a second channel (15) in an arc shape, wherein when a pressing force is simultaneously applied to the first channel (14) and the second channel (15), the first channel (14) and the second channel (15) are separately opened and closed opposite to each other such that when the first channel 14 is opened, the second channel is closed, and vice versa;
an inner cap (20) connected to the inside of a container neck (51) to discharge in use content (52) contained in a container (50), wherein the two-way duckbill valve (10) is positioned at the bottom of the inner cap (20) and a certain amount of the content (52) is stored in the inner cap (20);
a valve holder (30) connected to the lower part of the inner cap (20), to secure the two-way duckbill valve (10); and
a cover cap (40) threadedly engaging a container neck (51), wherein the upper end of the inner cap (20) fits into the cover cap (40).

2. The container cap according to claim 1, wherein the two-way duckbill valve (10) in the structure which gradually narrows from the cylindrical shape to the flattened shape comprises:
a valve body (11) in which the first channel (14) is formed at the upper end of the flattened shape;
a valve base (12) in a ring shape which is secured by the valve holder (30) and which the valve body (11) fits into; and
a bottom valve seat (13) which is the lower end of the valve body (11),
wherein the second channel (15) is formed between the bottom valve seat (13) and the inner circumferential surface of the valve base (12), and when a pressing force is simultaneously applied to the first channel (14) and the second channel (15), the valve body (11) and the bottom valve seat (13) are structured to separately open and close the first channel (14) and the second channel (15) opposite to each other.

3. The container cap according to claim 1, wherein the inner cap (20) comprises:
a body (21) in a cylindrical shape which fits into the inside of the container neck (51) and in which the content (52) is stored;
a flange (22) which extends outwardly from the top end of the body (21) so as to be placed on the top end of the container neck (51);
a lower support (23) formed at the bottom end of the body (21) such that the valve base (12) of the two-way duckbill valve (10) is seated;
an internal threaded part (24) formed in the lower inside circumferential surface of the body (21) to secure the valve holder (30); and
a sealing (25) positioned between the flange (22) and the top end of the container neck (51).

4. The container cap according to claim 1, wherein the valve holder (30) comprises:
an external threaded part (31) formed on the outer circumferential surface of the valve holder (30); and
two or more tool connection holes (32) formed on the top side of the valve holder (30).

5. The container cap according to claim 4, wherein the valve holder (30) further comprises a pressing protrusion (33) formed along the lower inside edge of the valve holder (30), to press the top side of the valve base (12) forming the two-way duckbill valve (10).

6. The container cap according to claim 1, wherein the cover cap (40) comprises:
an external connection part (41) threadedly engaging the outer circumferential surface of the container neck (51), to be sealed; and
an internal connection part (42) protruding downwardly from the inside of the top of the cover cap (40) so that the inner cap (20) fits into the cover cap (40).

7. The container cap according to claim 6, wherein the cover cap (40) further comprises: a sealing member (43) connected to the outside of the internal connection part (42), to press the top end of the inner cap (20) so as to be sealed.
